(19) United States
(12) Patent Application Publication
(10) Pub. No.: US 2014/0281546 A1
(43) Pub. Date: Sep. 18, 2014

(54) HEDI-Hopping-Enabled Dynamically-secured Intercommunication (AKA SockHop)

(71) Applicant: Michael D. Doyle, Wheaton, IL (US)

(72) Inventor: Michael D. Doyle, Wheaton, IL (US)

(73) Assignee: EOLAS TECHNOLOGIES, INC., Tyler, TX (US)

(21) Appl. No.: 14/202,559

(22) Filed: Mar. 10, 2014

Related U.S. Application Data
(60) Provisional application No. 61/779,600, filed on Mar. 13, 2013.

(51) Int. Cl. H04L 9/08

(52) U.S. Cl. CPC H04L 9/0838
USPC 713/171

(57) ABSTRACT

In one embodiment, a secure client-server socket-based Internet communication system uses socket hopping to distribute communication channels per session to a large number of randomly-selected socket ports.

### RELATED APPLICATION

This application claims the benefit of provisional application number 61/779,699 entitled HEDI-Hopping-Enabled Dynamically-secured Intercommunication (AKA SockHop) filed Mar. 3, 2013 which is incorporated by reference for all purposes.

### TECHNICAL FIELD

The present disclosure relates generally to secure communications between client/server systems over a network.

### BACKGROUND OF THE INVENTION

Port Blocking/filtering

The open Internet of the past is quickly fading away. While the rapid rise in popularity of the Web was due in large part to the fact that it democratized access to information, allowing individual web site owners to reach as many people as large corporations, that very popularity is now leading the providers of Internet services to create the equivalent of an electronic caste system, where only large and powerful corporations get access to the fast lane on the “Internet superhighway.”

The primary tool that Internet service providers use to accomplish this goal is by routinely selectively blocking or filtering network communications ports used by various applications to transfer data to and fro across the wide area networks. In many cases, those Web sites or network applications that are considered competitive or threatening in some way to the strategic interests of the ISP have their data-interchange performance either severely degraded or even blocked altogether.

Similarly, traffic moving across certain ports for these types of applications are routinely further manipulated and/or monitored to further the corporate interests of the Internet service providers. This type of anti-competitive behavior not only presents sometimes-insurmountable obstacles to the emergence of innovative new and disruptive technologies, it also represents a severe threat to the privacy of Internet users from all walks of life.

For the unsophisticated Internet user, such an unexplained instability in network application performance can also create attitudinal effects that can have unexpected negative consequences extending even to the very Internet service providers responsible for the performance degradation. Network applications are becoming such a pervasive part of everyone's life, spanning all the way from desktop computers even to the phones in our pockets, that no users can avoid using a wide array of applications from a large number of different software providers. Therefore, when selective performance degradation is subjected to these applications, it is inevitable that virtually all users experience the negative effects at one time or another.

The ultimate effect of such a circumstance is that overall user confidence in the Internet as a platform for accomplishing the tasks of daily life can be severely undermined. Just as a rising sea raises all ships, a vanishing sea beaches all boats.

Insecure Communication

The simplicity with which corporate espionage is able to be performed on unsuspecting Internet users can be startling. Many users don't employ secure channel technology, such as secure sockets layer (SSL), making them vulnerable to trivially-easy eavesdropping approaches, for example packet sniffing. Even those that do use SSL are often still vulnerable to man-in-the-middle attacks, where a spy possessing compromised cryptographic certificates inserts itself within the communications stream between the user and the destination web site.

As the incentives for such illegal surveillance increase, due to such factors as the U.S. switching to a first-to-file patent system, the need has increased for the availability of easy-to-use means to thwart such attacks.

A primary reason that existing Internet client-server communication applications are so easy to be eavesdropped upon, filtered or blocked is due to the previously-known default socket port numbers of popular applications. To increase application portability and to make it easier to install and maintain information systems, conventions have arisen by which specific types of network application data typically move across pre-determined network communication socket ports. The most familiar of these pre-defined ports, perhaps, it port 80, which is typically used for the transfer of data, using the HTTP protocol, between the Web server and the Web browser.

Blocking or filtering data moving across port 80, then, would degrade the user experience of any Web user whose data must traverse the portion of the network subject to the blocking or filtering activity. Since modern Web browsers routinely transmit browser-type information as a part of the initial Web page request, a sophisticated network provider could even cause only certain users' Web browsers to be affected, perhaps only those browsers created by a company that is a business rival to the Internet provider.

One simplistic approach to this problem is to change the default port number that a given application uses. However, even if alternate ports are used, when a fixed port is used for extended communications sessions, scanning and analyzing the traffic across multiple ports can often allow a third-party listener to identify the alternate port being used for a given software application.

A similar situation existed in the past, when radio-wave communications systems were used in World War II to control guidance systems for weapons such as submarine torpedoes. Enemy ships could often defend against torpedo attacks by using radio frequency jammers to scramble the guidance systems and send the torpedoes off course.

Hedy Lamar

An ingenious solution to this radio-control problem was created by the well-known movie star, Hedy Lamar, who was also an amateur inventor, and who, due to having been previously married to a German arms dealer, had acquired a surprisingly sophisticated knowledge of weapons of war.

Ms. Lamar had the insight that, if there could be a way to switch from one frequency to another during the communications session, and if it could be done in a way that would be unpredictable to an outside observer, then it would be practically impossible to jam the control signal.

She undertook to design such a system, and thereby created what is today known as spread spectrum technology. To accomplish is, Ms. Lamar and her co-inventor created an approach, now known as frequency hopping, to provide a secure communications channel to allow a submarine to remotely control a torpedo, continuously aiming it toward the target ship even after the torpedo was launched.

Lamar's system borrowed from player-piano technology in using paper tape scrolls on both the launching vessel, and onboard the torpedo itself. Holes in the tape at the launching vessel would cause the control radio transmission to switch from one radio frequency to another. Identical holes in the tape in the receiving system onboard the torpedo would allow the sender and receiver to communicate short bursts of information on the same frequencies, even while those frequencies would change by seemingly random amounts between the communication bursts. In this way, a hopeful signal jammer onboard the target ship would have no idea which radio frequency to try to jam. Even if the jammer accidentally hit upon and successfully jammed a portion of the communication, the weapons system would quickly move away from that jammed frequency, thereby thwarting the jamming efforts.

The sequences of frequencies would be used only once, and would be randomly varied from torpedo to torpedo. By keeping each sender/receiver paper tape pair secret, the enemy would have no way to predict which sequence would be used on any given torpedo fired.

In the decades since its initial invention, Lamarr's spread-spectrum approach has been used throughout the wireless radio communications industries to both reduce transmission loss due to radio frequency interference, and to add to the security of information communicated. In fact, the wifi and cellular wireless internet technologies prevalent today never would have been possible without use of Lamarr's invention created so long ago.

While, Lamarr's approach is appropriate for radio-frequency communications, it would be counter-intuitive to attempt to apply a similar approach to network communications. This is because network communications are not frequency based, and assume a widely-accepted set of pre-determined protocols to be adhered to at both the client and the server sides of the communication session.

The developers of Internet server software typically design their systems so that they are able to connect to clients created by other software developers. Therefore it would impractical or impossible for the server developers to deviate from the accepted protocols and port numbers and still be able to produce a system that works for many users.

### BRIEF DESCRIPTION OF THE DRAWINGS

FIG. 1 is a block diagram of an example embodiment;

FIG. 2 is a flow chart illustrating the operation of an example embodiment; and

FIG. 3 is a block diagram illustrating and example server or client computer workstation.

### DESCRIPTION OF EXAMPLE EMBODIMENTS

### Overview

The HEDI system is designed to secure client-server socket-based Internet communications, through the use of socket hopping to distribute communication channels per session to a large number of randomly-selected socket ports.

HEDI-based socket hopping begins with the client and server computers starting a communications session with each other on one socket port, using conventional socket-communication session initiation protocols. Once a connection is initiated, that port is only used for a very brief period of time. Then, either the client or server application, at one end or the other end of the communication session, randomly selects a new port for the session to continue upon, and securely transfers that new port number to the application at the other end. The client and server then initiate a new communications connection on the new port number, and the communication session continues.

Once the port number is determined by one computer and distributed to its communications partner application on the other computer, both applications then open a new socket on the new port number and continue the communication session on this new port number.

This process repeats until the communication session is ended. This approach makes it impractical for an eavesdropper, or a party attempting to block or filter the communications, to be able to predict what communication port to attempt to interfere with. Even if the data were being transferred in unencrypted form, the system would be vastly more secure than systems based on current approaches.

However, additional security can be obtained by encrypting the data being transferred over these channels.

One embodiment of the HEDI invention involves having port selection alternating between client and server. This results in a more secure system, since even if one of the two computers network connection is hacked, the eavesdropper would not be able to control the subsequent port assignments, and therefore wouldn't be enabled with enough information to defeat the system.

While encryption of communication channels can be employed, the HEDI system provides enhanced security by allowing for multiple sets of cryptographic keys to be used over the term of a single communications session, unlike current approaches which use only a single set of encryption keys during a single session.

The HEDI system allows for sub-session socket encryption keys to be exchanged via hopped sockets. Secure encrypted key exchange protocols, such as Diffie-Hellman key exchange, can be used to create and exchange the initial encryption key to be used on the first socket for the session to augment security. In this scenario, the first sub-session socket is used for only a very short time, then a large random number is used as the encryption key for the new socket.

This key is generated by either the client or the server computer, and then handed off from the computer at one end of the connection to the other as the final communication on that socket connection, before switching (hopping) to the new socket connection.

In this way, each new socket connection during a given communications session uses a new key on a new port, thereby dramatically increasing the difficulty for a potential eavesdropper in attempting to track, and subsequently crack, the communications from any point between the client side and server side of the communications.

To further enhance the security of the system, the system can further obfuscate the port numbers employed. To accomplish this, the session starts with the secure exchange of a random port-scrambling key, which is then used in the creation of a table of values wherein each value is a cryptographically generated ciphertext of each possible port number. As communications proceed, the scrambled (encrypted) port number is used for subsequent transfers of port numbers from either client to server, or for server to client. The port-number password can be varied at unpredictable intervals to enhance security.

As described below in the example embodiment shown, additional security can be provided through the use of third-party key exchange servers.

### DESCRIPTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, various embodiments may be practiced without some or all of these specific details. In other instances, well known process operations have not been described in detail in order not to unnecessarily obscure the present invention. Further, each appearance of the phrase an “example embodiment” at various places in the specification does not necessarily refer to the same example embodiment.

As depicted in the block diagram of FIG. 1 and the flow chart of FIG. 2, a communication session is initiated by having the client connect to a server port on the server, using routine and standard communication protocols, using, for example port 80 for http data communications. Once the communications socket is initiated, the client and server performs a Diffe-Hellman secure key exchange operation, to securely exchange two large random numbers, one to act as the session-data encryption key of the first sub-session, and the other to be used to create a table of scrambled port numbers. The session-data encryption key is used to encrypt the contents of the first-sub-session's data communication.

The first sub-session consists of the server sending the client a data bundle containing the following: 1) a sub-session bit-length, 2) data to the bit length in #1, 3) a randomly-selected scrambled port number to be used for the following subsession, and 4) a large random number to be used as the encryption key for the following sub-session

The current sub-session socket connection is closed. The client decrypts the first sub-session data bundle, decrypts the scrambled port number, copies the decrypted “data to the bit length” to an application data stream, and then a new sub-session is initiated using the port number and encryption key appended to the data of the prior sub-session.

This process is repeated until the final application data segment is received and processed by the client. Any open sockets are closed, and the communication session is ended.

For bi-directional communications, server and client roles can be swapped for sub-sessions during a full session, or separate send and receive sessions can be created.

The HEDI system, therefore creates a chained set of communication subsessions, traversing a random series of port numbers, with the key used in the current sub-session being transmitted during the previous sub-session. The security of this example embodiment relies on the inability of the eavesdropper to eavesdrop on the first session.

Another approach is to use a third computer, a secure key exchange server, to send the scrambled port numbers and sub-session encryption keys to both the application session client and server computers. This approach adds enhanced security by requiring the eavesdropper to eavesdrop not only on the initiation of the communication session, but also on each communication of sub-session data from the key-exchange computer to both the client and the server computer.

To even further enhance the security of the system, a network of many such third-party servers can be employed, wherein any server can serve as a key exchange server for any requestor at any time. The client and server computers can randomly select a key-exchange server at the beginning of each session, and can subsequently switch among the available key-exchange servers for later communication sessions.

Even if a third-party key-exchange server is not used, additional enhancement to security can be obtained by occasionally re-initiating the sub-session chains by exchanging new keys via Diffe-Hellman key exchange.

While inspired by the WWII-era work of Hedy Lamarr, the HEDI system uses a new and surprising approach for bi-directional communications over the network, while also providing enhanced security and resistance both to eavesdropping by third-parties, and to blocking/filtering of communications by malicious Internet service providers.

FIG. 3 is an illustration of basic subsystems in a client or server computer system workstation. In FIG. 3, subsystems are represented by blocks such as central processor 180, non-transitory system memory 181 consisting of random access memory (RAM) and/or read-only memory (ROM), display adapter 182, monitor 183, etc. The subsystems are interconnected via a system bus 184. Additional subsystems such as a printer, keyboard, fixed disk and others are shown. Peripherals and input/output (I/O) devices can be connected to the computer system by, for example serial port 185. For example, serial port 185 can be used to connect the computer system to a modem for connection to a network or serial port 185 can be used to interface with a mouse input device. The interconnection via system bus 184 allows central processor 180 to communicate with each subsystem and to control the execution of instructions from system memory 181 or fixed disk 186, and the exchange of information between subsystems. Other arrangements of subsystems and interconnections are possible.

Some example embodiments are implemented as program code embodied in a non-transitory computer readable storage medium. The program code is executed by one or more processors to perform the steps described above.

Various example embodiments have been described above. Alternatives and substitutions will now be apparent to persons of skill in the art. Accordingly, it is not intended to limit the invention except as provided by the appended claims.

What is claimed is:

1. A communication system comprising:
one or more processors;
a computer readable memory holding program code which, when executed by the one or more processors, performs the following acts:
connecting to client computer on server port 80;
performing secure key exchange with client computer; and
sending sub session bit length, data to the bit length, randomly selected port number and large random number for encryption key.
